(19) United States
(12) Patent Application Publication
(10) Pub. No.: US 2007/0024046 A1
(43) Pub. Date: Feb. 1, 2007

(54) Book with at least one moveable object implanted therein

(75) Inventor: Peng Cheong Loo, Easton, CT (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Rocket Books, Inc.

(21) Appl. No.: 11/193,553

(22) Filed: Jul. 28, 2005

(51) Int. Cl. B42D 1/00

(52) U.S. Cl. 281/15.1

(57) ABSTRACT

A board book is provided with an at least one moveable object subassembly which is more appealing than the conventional plain hard cover. Each moveable object may be adorned with illustrations and the like to represent the contents of the book.

### BACKGROUND OF THE INVENTION

1. Field of the Invention

This invention relates to the field of books and, more particularly, it relates to the construction of books for children of the type known as “board books” having at least one moveable object implanted therein.

2. Description of the Background Art

Board books are manufactured primarily for small children who would have difficulty turning the pages of a conventional book. These books are designed in such a way that each page comprises two layers of cardboard-like material which are cemented together. These books normally just have text and illustrations and lack playthings such as moveable objects. It would be advantageous to provide a book which has playthings to attract and hold the attention of the child reader. In addition, such moveable objects could be amenable to the application of representations of the contents of the book.

### SUMMARY OF THE INVENTION

The present invention is designed to overcome the above limitations that are attendant upon the use of “prior art” devices, and toward this end, it contemplates the provision of a novel board book with moveable objects implanted therein.

It is an object of the present invention to provide such a board book in which the moveable objects are readily viewable as the entire book is being read.

It is also an object to provide such a board book in which the moveable objects have representations of the contents of the book thereon.

It is a general aim of the invention to provide such a board book which may be readily and economically fabricated and will have long life in operation and significantly greater flexibility in use.

It has now been found that the foregoing and related objects can be readily attained in a board book which includes front and back cover members separated by a spine member, a plurality of folded sheets intermediate the front and back cover members thereby forming interconnected multiple pages spaced from the spine member, at least one of the front and back cover members and the interconnected multiple pages defining at least opening therein, and a subassembly having at least one moveable object thereon and spanning across the at least one opening. Each of the front and back cover members and the interconnected multiple pages can be made from cardboard.

Preferably, the at least opening is an opening defined in each of the front and back cover members and the interconnected multiple pages and the subassembly having the at least one moveable object thereon spans across one of the openings in one of the front and back cover members and the interconnected multiple pages. The subassembly can extend into all of the openings in each of the front and back cover members and the interconnected multiple pages when the book is in a closed position. In the preferred embodiment, the subassembly having the at least one moveable object thereon spans across the opening in one of the interconnected multiple pages.

In a second embodiment, the at least one opening is defined in the front cover member and the subassembly having the at least one moveable object thereon spans across the opening in the front cover member.

Ideally, the subassembly has an elongated cylindrical stem with a flange on each end, each flange being implanted in the at least one of the front and back cover members and the interconnected multiple pages defining at least opening therein so that the elongated cylindrical stem spans across the at least one opening. The at least one moveable object is rotatably mounted on the elongated cylindrical stem which can be made of two pieces joined at ends thereof. One of the pieces of the elongated cylindrical stem has a reduced diameter end portion which is matingly received within an opening defined in the other piece of the elongated cylindrical stem.

Conveniently, the subassembly includes spacers engaging each moveable object to keep them spaced from one another and the at least one opening.

According to the invention, the subassembly having the at least one moveable object thereon and spanning across the at least one opening is implanted in the at least one of the front and back cover members and the interconnected multiple pages defining the at least opening therein. The subassembly can have two flanges which are implanted in the at least one of the front and back cover members and the interconnected multiple pages defining the at least opening therein. The at least one of the front and back cover members and the interconnected multiple pages defining the at least opening therein has cutouts dimensionally sized to hold the two flanges.

Also, the at least one moveable object may faces which illustrate representations of the contents of the book. These faces can be on a wooden block.

In still a further feature of the invention, each at least one moveable object has a geometrical shape and the geometrical shape of each at least one moveable object matches a geometrical shape of its corresponding at least one opening.

The invention will be fully understood when reference is made to the following detailed description taken in conjunction with the accompanying drawings.

The invention will be fully understood when reference is made to the following detailed description taken in conjunction with the accompanying drawings.

### BRIEF DESCRIPTION OF THE DRAWINGS

FIG. 1 is a perspective view of a book of the present invention in a closed position and having at least one moveable object implanted therein;

FIG. 2 is a front view of the book of FIG. 1;

FIG. 3 is a right side view of the book of FIG. 1;

FIG. 4 is a perspective view of a book of FIG. 1 in an opened position and having parts of its middle page broken away to illustrate internal structure;

FIG. 5 is an exploded perspective view of the at least one moveable object subassembly;

FIG. 6 is a perspective view of a portion of the middle page of the book of FIG. 1 having parts broken away and exploded to illustrate internal structure;

FIG. 7 is a perspective view of a second embodiment of the book of the present invention shown in its open position and having parts broken away to illustrate internal structure; and

FIG. 8 is an exploded perspective view of one of the at least one moveable object subassemblies of FIG. 7.

### DETAILED DESCRIPTION OF THE INVENTION

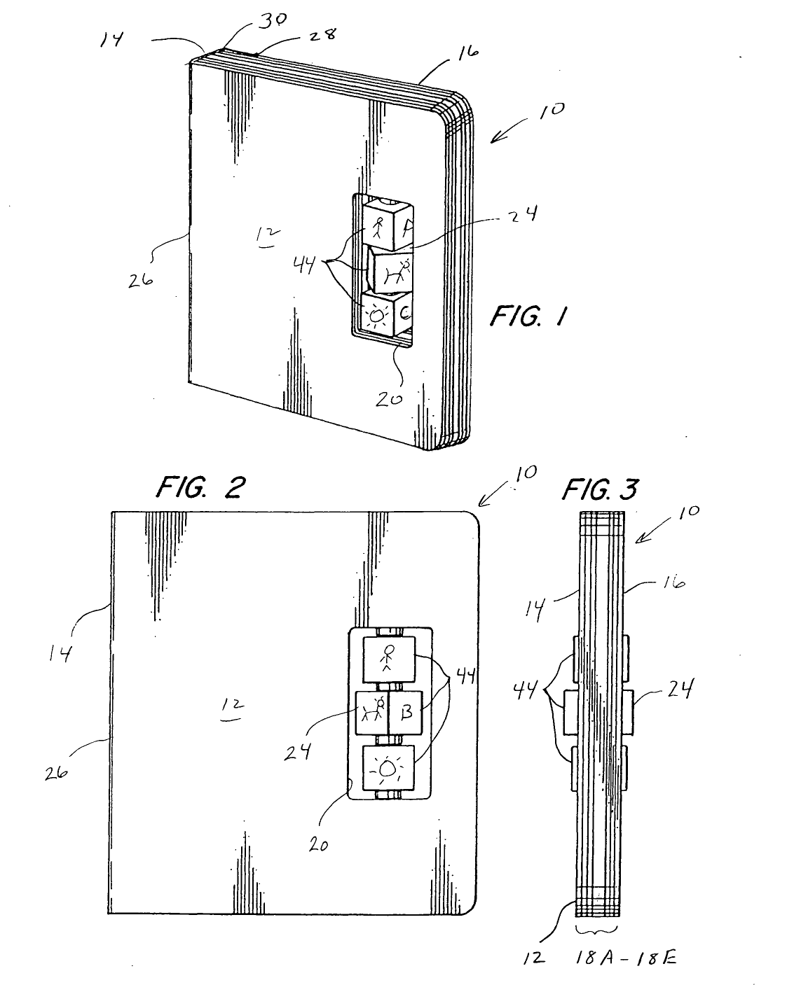

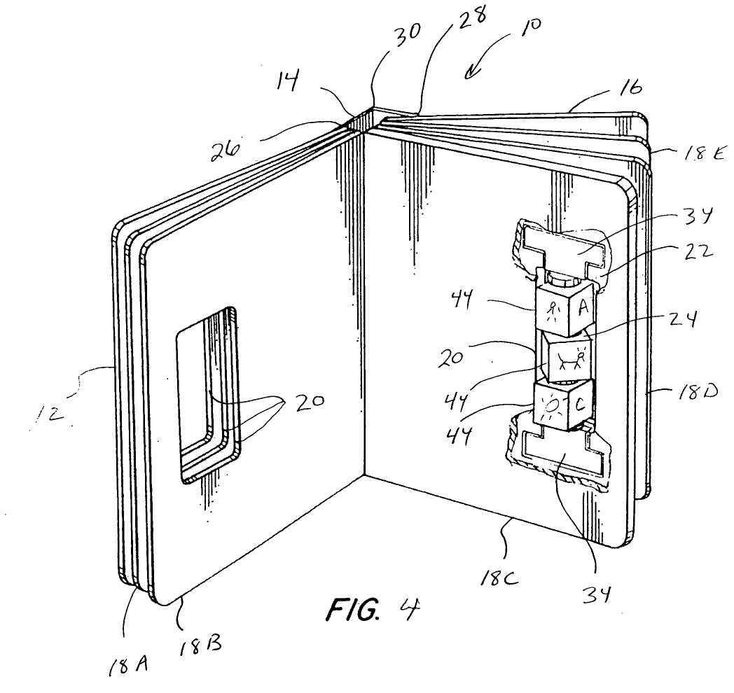

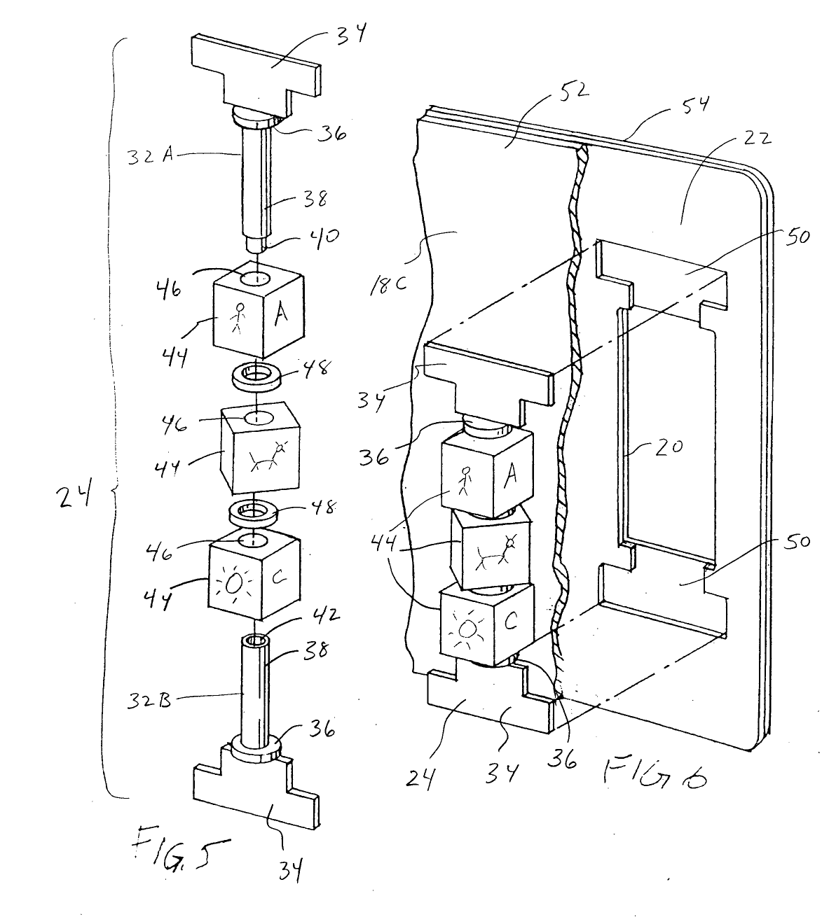

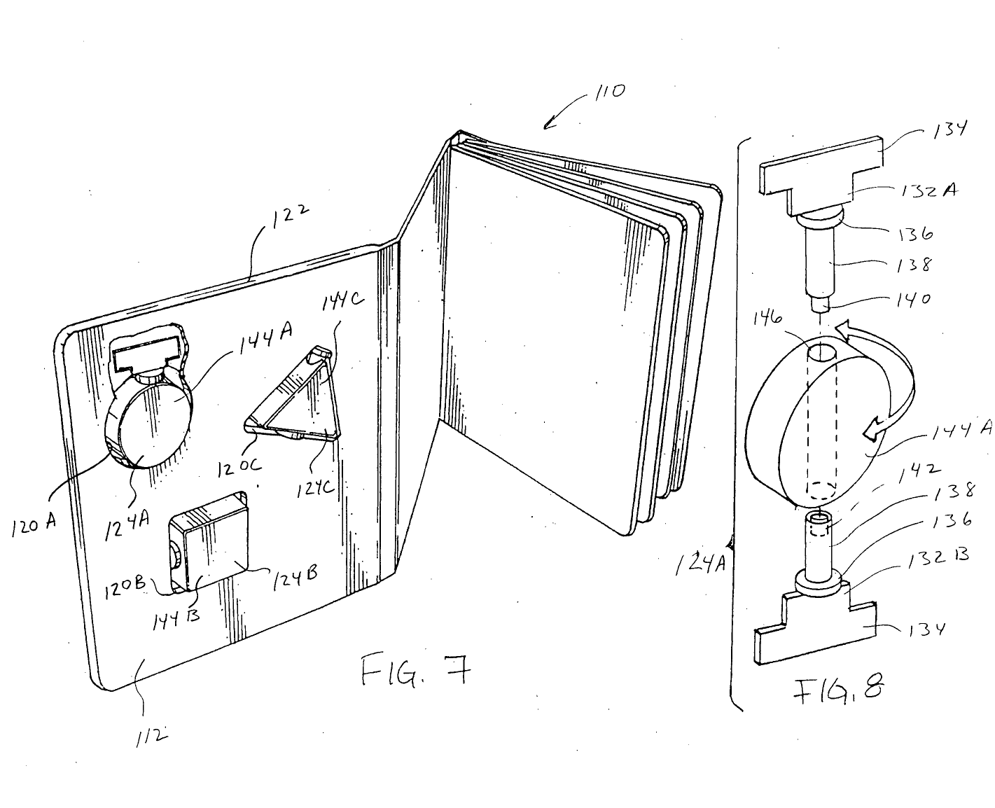

Turning first to FIGS. 1-4 of the drawings, therein illustrated is a board book generally designated by the numeral 10 and comprised of a substantially rectangular pivoted front cover 12, an elongated spine 14 and a substantially rectangular pivoted back cover 16 with a plurality of pages 18A -18E therebetween, all with generally rectangular die-cut apertures 20 therein.

The phrase “board book” arises from the fact that books of this type have very stiff, thick pages which can be turned more easily by a very small child than can conventional thin paper pages. In a well known manner, the covers 12, 16 and pages 18A-18E are each formed from two layers of stiff material such as cardboard sheets folded to produce substantially similar front and back covers 12,16 separated by the spine 14 and a plurality of folded sheets intermediate the covers 12,14 thereby forming the interconnected multiple pages 18A - 8E spaced from the spine 14. Thus, each of the covers 12, 16 and pages 18A-18E is a composite made up of multiple layers which are cemented together. The middle page 18C is relatively thick as it has an extra middle layer 22 (FIG. 6) and has an at least one moveable object subassembly 24 in its aperture 20 therein.

As best illustrated in FIG. 4, the front cover 12 is hinged to the spine 14 by a front hingeline 26. The back cover 16 is similarly hinged to the spine 14 by a back hingeline 28. To account for the thickness of the board book 10, the back cover 16 includes a secondary hingeline 30 which prevents the book 10 from binding when it is opened.

Referring to FIGS. 4-6, the at least one moveable object subassembly 24 has a pair of molded plastic support members 32A, 32B, each with a T-shaped flange 34, a disk-shaped spacer 36 and an elongated cylindrical stem 38. The disk-shaped spacers 36 can be a separate element or integral with the support members 32A, 32B. The support member 32A has a reduced diameter portion 40 which is matingly received within an opening 42 in the end of the cylindrical stem 38 of the support member 32B. The at least one moveable object subassembly 24 also has three moveable objects 44 in the form of wooden blocks with thru bores 46 dimensionally sized to be rotatably received on the elongated cylindrical stems 38 of the support members 32A, 32B. The faces of the objects 44 can be used to illustrate representations of the contents of the book 10. Two plastic washers 48 are also dimensionally sized to be received on the elongated cylindrical stems 38 of the support members 32A, 32B intermediate the objects 44. During the assembly of the at least one moveable object subassembly 24, adhesive can be placed on the reduced diameter portion 40 to secure the support members 32A, 32B together once the reduced diameter portion 40 is matingly received in the opening 42.

As seen in FIGS. 4 and 6, the middle layer 22 of the middle page 18C has two cutouts 50 into which the T-shaped flanges 34 are inserted. The opposed layers 52, 54 of cardboard sandwich the middle layer 22 to hold the at least one moveable object subassembly 24 in the middle page 18C by means of the flange 34.

The support members 32A, 32B and the washers 48 are preferably molded from a plastic resin material such as polyethylene, polypropylene, high impact polystyrene, impact modified acrylic or the like. The objects 44 are preferably wooden. It should be to those skilled in the art that these components may be manufactured from other suitable materials.

In use, the reader can view and rotate the moveable objects from each page as the book 10 is read from front to back and can also view and rotate the moveable objects 44 when the book 10 is closed. Since such moveable objects 44 can have representations of the contents of the book 10 thereon, the objects 44 attract and hold the attention of the child reader.

Turning now to FIGS. 7 and 8, another embodiment of the book is illustrated therein and generally indicated by the reference numeral 110. This embodiment differs from the first embodiment in that the front cover 112 is thickened by a middle layer 122 and three moveable object subassemblies 124A-124C are implanted therein.

As best seen in FIG. 8, the moveable object subassembly 124A has a pair of molded plastic support members 132A, 132B, each with a T-shaped flange 134, a disk-shaped spacer 136 and an elongated cylindrical stem 138. The disk-shaped spacers 136 can be separate elements or integral with the support members 132A, 132B. The support member 132A has a reduced diameter portion 140 which is matingly received within an opening 142 in the end of the cylindrical stem 138 of the 132B. The subassembly 124A also has a single moveable object 144A in the form of a circular wooden disk with a thru bore 146 dimensionally sized to be rotatably received on the elongated cylindrical stems 138 of the support members 132A, 132B. The faces of the object 144A can be used to illustrate representations of the contents of the book 110. During the assembly of the moveable object subassembly 124A, adhesive can be placed on the reduced diameter portion 140 to secure the support members 132A, 132B together once the reduced diameter portion 140 is matingly received in the opening 142. The moveable object subassemblies 124B, 124C are identical to moveable object subassembly 124A except for the shapes of the objects 144A, 144B, 144C. The shapes of apertures 120A, 120B, 120C match the shapes of their corresponding objects 144A, 144B, 144C.

To use the book 110 of FIG. 7, the reader would fold out the front cover 112 as shown in order to be able to view and rotate the moveable objects 144A, 144B, 144C as the book is read.

Thus, artisans skilled in the art will appreciate that the book of the present invention as described herein can be employed advantageously to attract and hold the attention of child readers in an efficient and convenient manner. It will, therefore, be seen from the above that the invention described admirably achieves the objects of the invention. However, it will be appreciated that departures can be made by those skilled in the art without departing from the spirit and scope of the invention, which is limited only by the following claims.

What is claimed is:

1. A board book comprising:
front and back cover members separated by a spine member;
a plurality of folded sheets intermediate the front and back cover members thereby forming interconnected multiple pages spaced from the spine member;
at least one of the front and back cover members and the interconnected multiple pages defining at least opening therein; and
a subassembly having at least one moveable object thereon and spanning across the at least one opening.

2. The board book of claim 1, wherein the at least opening is an opening defined in each of the front and back cover members and the interconnected multiple pages and the subassembly having the at least one moveable object thereon spans across one of the openings in one of the front and back cover members and the interconnected multiple pages.

3. The board book of claim 2, wherein the subassembly extends into all of the openings in each of the front and back cover members and the interconnected multiple pages when the book is in a closed position.

4. The board book of claim 3, wherein the subassembly having the at least one moveable object thereon spans across the opening in one of the interconnected multiple pages.

5. The board book of claim 1, wherein the at least one opening is defined in one of the interconnected multiple pages and the subassembly having the at least one moveable object thereon spans across the opening in the one of the interconnected multiple pages.

6. The board book of claim 1, wherein the at least one opening is defined in the front cover member and the subassembly having the at least one moveable object thereon spans across the opening in the front cover member.

7. The board book of claim 1, wherein each of the front and back cover members and the interconnected multiple pages is cardboard.

8. The board book of claim 1, wherein the subassembly has an elongated cylindrical stem with a flange on each end, each flange being implanted in the at least one of the front and back cover members and the interconnected multiple pages defining the at least opening therein so that the elongated cylindrical stem spans across the at least one opening.

9. The board book of claim 8, wherein the at least one moveable object is rotatably mounted on the elongated cylindrical stem.

10. The board book of claim 8, wherein the elongated cylindrical stem is made of two pieces joined at ends thereof.

11. The board book of claim 10, wherein one of the pieces of the elongated cylindrical stem has a reduced diameter end portion which is matingly received within an opening defined in an end of the other piece of the elongated cylindrical stem.

12. The board book of claim 1, wherein the subassembly includes spacers engaging each moveable object to keep them spaced from one another and the at least one opening.

13. The board book of claim 1, wherein the subassembly having the at least one moveable object thereon and spanning across the at least one opening is implanted in the at least one of the front and back cover members and the interconnected multiple pages defining the at least opening therein.

14. The board book of claim 13, wherein the subassembly has two flanges which are implanted in the at least one of the front and back cover members and the interconnected multiple pages defining the at least opening therein.

15. The board book of claim 13, wherein the at least one of the front and back cover members and the interconnected multiple pages defining the at least opening therein has cutouts dimensionally sized to hold the two flanges.

16. The board book of claim 1, wherein the at least one moveable object has faces which illustrate representations of the contents of the book.

17. The board book of claim 1, wherein each at least one moveable object is a wooden block.

18. The board book of claim 1, wherein each at least one moveable object has a geometrical shape.

19. The board book of claim 18, wherein the geometrical shape of each at least one moveable object matches a geometrical shape of its corresponding at least one opening.
